(19) United States
(12) Patent Application Publication
(10) Pub. No.: US 2014/0279051 A1
(43) Pub. Date: Sep. 18, 2014

(54) Real-Time Advertising System

(71) Applicant: CBS Interactive Inc., San Francisco, CA (US)

(72) Inventor: John Andrew Curtis, Roseville, OH (US)

(73) Assignee: CBS Interactive Inc., San Francisco, CA (US)

(21) Appl. No.: 14/200,587

(22) Filed: Mar. 7, 2014

Related U.S. Application Data
(60) Provisional application No. 61/789,617, filed on Mar. 15, 2013.

(51) Int. Cl. G06Q 30/02

(52) U.S. Cl. CPC G06Q 30/0273
USPC 705/14.69

(57) ABSTRACT

Disclosed are systems, methods, and non-transitory computer-readable storage media for identifying and assigning advertisements to impression slots based on each advertisement's impression set. An advertisement has one or more attributes, or impressions, that characterize it, which are collectively known as an impression set. Media content providers may take into account an advertisement's impression set when linking advertisements to impression slots. By iterating through a direct access table that contains impression slots and pointers, an advertisement inventory server can link, re-link, and award impression slots to the advertisement that has the highest value. The resulting direct access table shows the value-optimized impression slot assignments as well as the unsold inventory of impression slots in real-time. Furthermore, if a query is submitted, the advertisement inventory server can include the query results in the direct access table.

### RELATED APPLICATIONS

This application claims the benefit of U.S. Provisional Application No. 61/789,617 entitled “Real-Time Advertising System” filed on Mar. 15, 2013 to John Andrew Curtis, the contents of which are incorporated by reference herein.

### BACKGROUND

1. Technical Field

The present disclosure relates to identifying real-time inventory of advertisements and more specifically to the proper maximal delivery method of advertisements when said advertisements overlap.

2. Introduction

The Internet provides a fast and efficient way of distributing information to people in various locations. People use the Internet in order to perform a variety of tasks, which may include reading the news, communicating with other people, writing stories or posts, checking stock prices and the like. With an increased number of people using the Internet every day, content providers are pressed to find methods of generating revenue for their online content. Some content providers solve the issue using protected sites that require payment in order to gain access to the content. Other content providers may sell physical products, such as merchandise, tickets, goods and the like, in order to have a source of revenue. Regardless of the method, the generation of revenue is an increasingly important aspect for content providers on the Internet, especially as an increasing amount of people continues to contribute to online traffic.

In response to the issue of revenue generation, online content providers increasingly turn to advertisements as a solution. Advertisements are any form of communication performed primarily for marketing purposes. Third party individuals or organizations may create and provide these advertisements to content providers for content providers to include in distributed media. These advertisements may be used in various forms, such as short video clips, long infomercials, pop-up windows, screen overlays, embedded metadata, images and so forth. Content providers may include these advertisements in various ways in online content. For example, content providers may segment provided media (e.g., video streams) to include advertisements in between segments, have advertisements appear over certain parts of the provided media content (e.g., pop-up ads), temporarily redirect viewers to an advertisement page, and so forth. In return to including advertisements in distributed content, content providers often receive payment or revenue from the third party advertisement providers.

However, media content providers often have a limited number of available slots in media contents to insert advertisements. These slots may be referred to as advertisement slots and are often sold to different advertisement providers. Oftentimes, several advertisement providers compete for advertisement slots, providing media content providers with a large inventory of advertisements to choose from. Each advertisement provider creates unique advertisements targeted at a desired audience. Each of these advertisements has certain attributes, or impressions, that characterize it. For example, some impressions may relate to targeted age groups, targeted gender, site context, advertisement creator, advertisement type, advertisement genre, search terms and the like. Advertisements typically are sold with the expectation that they will have one or more impressions. Typically, an expected set of impressions based upon the past and future projections are used to determine an advertisement's expected availability. Each impression's attributes are indexed in some searchable index which can return impressions based upon some expression. An impression might be a click on a baseball web page by a 35 year old male in Texas. An advertisement will often have an expression associated with it that can be used as a filter or query against the set of all impressions. For example, the above impression would match expressions or advertisements requesting “males in Texas” or “30-40 males” or baseball web pages. An impression typically has many more attributes than listed above and expressions from advertisements typically are more complex than the examples above as well

Media content providers may encounter an issue when attempting to select advertisements to fill advertisement slots in their media content. At times, media content providers may not know how much inventory of advertisements slots they have to sell to advertisers. Media content providers may also specify advertisements with certain impressions to fill specific advertisement slots. In addition, media content providers may also want to determine the most efficient use of each slot (e.g., maximizing revenue per slot). However, current solutions do not effectively account for the combination of advertisement impressions, advertisement value, advertisement slot impressions specifications and total inventory in determining advertisement slot assignments in real-time.

### BRIEF DESCRIPTION OF THE DRAWINGS

In order to describe the manner in which the above-recited and other advantages and features can be obtained, a more particular description of the principles briefly described above will be rendered by reference to specific embodiments thereof which are illustrated in the appended drawings. Understanding that these drawings depict only exemplary embodiments and are not therefore to be considered to be limiting of its scope, the principles herein are described and explained with additional specificity and detail through the use of the accompanying drawings in which:

FIG. 1 illustrates an example advertisement inventory server;

FIG. 2 illustrates an example inventory identification and query processing method embodiment;

FIG. 3 illustrates an example impression set linking method embodiment;

FIG. 4 illustrates an example impression slot awarding method embodiment;

FIG. 5A illustrates an example impression slot initial allocation embodiment; and

FIG. 5B illustrates an example impression slot final allocation embodiment.

### DETAILED DESCRIPTION

Various embodiments are discussed in detail below. While specific implementations are discussed, it should be understood that this is done for illustration purposes only. A person skilled in the relevant art will recognize that other components and configurations may be used without parting from the spirit and scope.

### Overview

The present disclosure relates to identifying real-time inventory of advertisements and more specifically to the proper maximal delivery method of advertisements when said advertisements overlap. In one embodiment, maximum delivery may be in advertisements delivered, a delivery which maximizes revenue, or some combination of the two. The advertisements can be made up of arbitrary attributes. One advertisement may overlap with other advertisements in part or entirely.

The disclosed configurations (e.g., systems, methods, and non-transitory computer-readable storage media) include identifying and assigning advertisements to impression slots based on each advertisement's impression set. This advertisement inventory server is a service which shows available inventory and can be used as a database for previously sold inventory along with unsold inventory. It can also be used to aid the delivery of ads by prioritizing ads for the services which serve them, such as advertisement providers or third party providers. As mentioned previously, advertisements are a form of communication that is performed primarily for marketing purposes. Advertisements may be produced by advertisement providers and are supplied to media content distributors to include in media sent to viewers. By including these advertisements, which may come in forms such as short video clips, long infomercials, pop-up windows, screen overlays, embedded metadata, images and so forth, media providers gain a source of revenue from advertisement providers. However, media providers face an issue of not knowing how much advertisement inventory or advertisement slots that they have available to be sold in real-time.

In one example embodiment, as further described herein, media providers to identify overlapping sets to see what items are not in any overlapping sets, which comprise unsold inventory. Each advertisement has various attributes, or impressions, associated with it. Impressions may include such things as advertisement type, advertisement length, targeted age range, targeted gender, context, advertisement creator and the like. Advertisements offered to media providers may have a list of impressions associated with it already, or media providers may analyze advertisements to identify impressions. Using these impressions, each advertisement can be associated with an impression set, which are lists that contain impressions that may be associated with an advertisement. For example, an advertisement for a football game may have the following impressions associated with it: content type—sports/NFL, targeted age range—18-24, advertisement provider—CBS Sports, advertisement type—short clip, length—30 seconds, targeted gender—male, and so forth. These impressions form the impression set for the football game advertisement. Each advertisement that is available to a media content provider can be analyzed and categorized according to an impression table. An impression table is a table listing all of the available advertisements and their associated impression sets.

Media content providers integrate advertisements into provided media in order to generate revenue. However, media content providers often attempt to improve a viewer's experience by selecting targeted advertisements. Thus, for a media content provider's available inventory of advertisement slots, the provider may want to have certain of these slots assigned to advertisements with specific impressions. In this scenario, the advertisement slots may be referred to as impression slots. An advertisement slot is an opening in the media content provider's distributed media that is normally reserved for advertisements. Impression slots are a specific type of advertisement slot, where the media content provider has identified a specific impression that an advertisement placed into the advertisement slot should have. By searching through each advertisement's impression table, a media content provider is able to identify and select specific advertisements suitable for each impression slot in its inventory. Furthermore, each advertisement may be of different value to the media provider. For example, some advertisements may generate more revenue, are more worthwhile to show viewers, generate more goodwill, produce more benefits or other such factors. Media content providers may use these values in conjunction with impression tables to determine how to best allocate available impression slot.

Advertisement providers or other entities may occasionally submit queries to media content providers regarding an additional advertisement placement within the media content providers' distributed media. Media content providers may also submit queries in the interest of optimizing the advertisement selection. When media content providers receive a query, the media content providers retrieve and analyze each of its available advertisements for impressions within its advertisement inventory servers. In an embodiment, a query may represent an advertisement provider or other entities' intention of submitting an advertisement of specified impressions and value to a media content provider. However, before submitting the advertisement, the entity may wish to determine which impression slots it may be awarded (e.g., slotted or inserted into a designated position within a table or listing) according to specified impressions and value. An advertisement inventory server extracts impression information and identifiers from each available advertisement, along with the impressions from the query, and arranges them into impression sets. Each advertisement is associated with its own impression set, with the entire available store of advertisements and associated impression sets arranged into an impression table. It is important to note that a query is not different than a committed advertisement with the possible exception that one may want to see the impact of adding an advertisement (and its associated rules) to the set. In another embodiment, the rules of all of the advertisements may be changed by adjusting them to provide maximal delivery. Any advertisement can be changed, deleted, or added in real-time by simply excluding, updating, or inserting it. Since each advertisement is a structure with a reference to the associated impression identifiers (either implicitly or computed), the set and/or zero or more weights associated with the set may be modified.

To organize the available advertisements and query into impression slots, advertisement inventory server may use a direct access table to link impression slots and specific advertisements. In an embodiment, a direct access table may contain a series of impression slots, each associated with a pointer. Other embodiments may utilize other forms of reference methods such as keeping a list of matching advertisements for each impression. Impression slots may also be assigned a weight and/or represent zero or more real impressions. For example, if a given impression is assumed to occur ten times, the advertisement which wins the given slot may get ten impressions. Advertisements are linked to impression slots that correspond to impressions in each advertisement's impression set using a pointer. There may be two different types of pointers: one to indicate a tentative link and a second to indicate an awarded slot. In an embodiment, each advertisement may have only one link pointer associating it to an impression slot in a direct access table. However, the advertisement may have multiple award pointers associating it to impression slots in a direct access table. Awarding establishes a more permanent association between an advertisement (if for delivery) or a set of advertisements (if for availability) and an impression slot. Furthermore, awarding for delivery establishes that an advertisement is assigned to a specific impression slot, and the impression slot cannot have another advertisement assigned to it without replacing the original advertisement. A slot can have multiple advertisements for availability assuming none are needed for delivery.

In an embodiment, an advertisement inventory server may link advertisements to impression slots with queried slots blocked out on a first iteration. On a second iteration, queries are treated the same as advertisements with the non-query set blocked out. Thus, queries and advertisements are linked, awarded, and re-linked to impression slots based on each of their impression set. The end result of the dual iterations is that media content providers can identify impression slots that remain not awarded (available inventory of impression slots) as well as determine how queries will affect their advertisement line-up. For example, media content providers may realize that a lower valued query is not able to be awarded certain impression slots due to other higher valued advertisements. The entity submitting the query can then be informed of the results and make appropriate changes. For example, the query submitter may choose to increase payment to the media content providers for including an advertisement in distributed media, which may boost the value of the query. Higher valued queries may be more competitive when advertisement inventory server links and award impression slots and advertisements.

Another embodiment includes the ability to optimize advertisements for delivery. In this example embodiment, only one iteration is used. Once the iteration is complete, each advertisement may have the number of impressions awarded to them and the potential number of impressions that could have been awarded. Some advertisements may not be able to deliver and this can note that and give more priority to such advertisements. Additionally, some advertisements will be able to easily deliver their goal and can have the priority lessoned.

### Example Advertisement Inventory Server

A system, method and non-transitory computer-readable media are disclosed which identify the advertisement impression sets, links advertisements to impression slots, and awards impression slots to advertisements in part to identify remaining inventory and optimize queries. To better understand the disclosed configuration, a brief introductory description of an embodiment of an advertisement inventory server is provided in conjunction with FIG. 1. In an embodiment, advertisement inventory server 100 may be part of any computing device that is capable of receiving requests and commands, processing data, and outputting data. The advertisement inventory server 100 can be employed to practice the concepts that are disclosed herein.

With reference to FIG. 1, an exemplary advertisement system 100 includes user interface module 102, ad analyzer module 104, impression table generator module 106, ad iteration module 108, impression table iteration module 110, direct access table iteration module 112, link module 114, increment module 116, comparator module 118, ad database 120, impressions data base 122, and direct access table 124. It is noted that in some embodiments two or more module may be configured to combine their functionality. Further, other embodiments of advertisement inventory server 100 may include different modules than what is illustrated by the embodiment in FIG. 1, but with similar functionality. It should be noted that the use of a direct access table provides optimal performance, but other approaches could work, such as using a hash array, keeping advertisements in a heap or binary tree, etc. This embodiment explains the direct access table approach, but anyone skilled in the art would recognize that other approaches could be used as a substitute for the direct access table. The approach would be the same, but the end result would be a process that likely performs the task at a slower rate of speed.

In an embodiment, user interface module 102 processes data from other components of advertisement inventory server 100 and generates an interface from the processed data. The interface 102 is communicated to viewing devices, such as display monitors, for advertisement inventory server 100 operators to interact with the server 100. For example, when operators submit queries to advertisement inventory server 100, the queries are entered via user interface module 102 before being processed into data that is transmitted to other modules. Data from other modules are also received by user interface module 102 and processed into visual data for operators to understand.

An ad analyzer module 104, in an embodiment, retrieves advertisements from ad database 120 and impressions database 122 and extracts impressions identifiers from each advertisement. Ad analyzer module 104 may identify impressions through metadata that may be associated with each advertisement. For example, an advertisement may have metadata associated with it identifying file lengths, sizes, names, creation dates and the like associated with it. An ad analyzer module 104 may also identify tags that advertisement providers may have attached to advertisements provided to advertisement inventory server 100, such as targeted age range, targeted gender, creator identification, associated organizations and so forth. In some embodiments, ad analyzer module 104 may also process the ad analyzer's contents in order to determine impressions. For example, ad analyzer module 104 may run audio and video analysis algorithms, along with other algorithms, to detect patterns or key words/images and use the extracted information to infer attributes. The list of impressions for each advertisement is then associated with the advertisement as an impression set.

Impression table generator module 106 acquires the advertisements and their associated impression sets and constructs an impression table from them, in accordance with an embodiment. An impression table generator module 106 creates a table that lists each advertisement (or query), their associated values, and the list of impressions that each advertisement can be categorized as. The impression table provides a basis for later modules to compare advertisements and link these advertisements to available impression slots.

Ad iteration module 108, in an embodiment, cycles through the advertisements in the impressions table as part of the process for initially linking advertisements to impression slots. Ad iteration module 108 works in conjunction with increment module 116 to select advertisements for linking to impression slots and then incrementing to the next advertisement available in the impression table. Ad iteration module 108 also checks whether an advertisement is linked to the direct access table. For advertisements not already linked to the direct access table, ad iteration module 108 prompts impression table iteration module 110 for further action.

Impression table iteration module 110, in an embodiment, cycles through impression sets in an impression table to check for impression slot contentions, link advertisements to impression slots, and resolve issues with slot contentions. An impression slot contention occurs when two different advertisements are both categorized as having one or more identical impressions, and thus are competing for the same impression slot on a direct access table. Impression table iteration module 110 works in conjunction with link module 113, increment module 116, and comparator module 118 to cycle through an impression table, link advertisements to impression slots, and resolve issues with contentions.

In an embodiment, direct access table iteration module 112 cycles through a direct access table containing a list of impression slots. Working in conjunction with increment module 116, direct access table iteration module 112 checks each impression slot in the direct access table for linked advertisements. For impression slots that have linked advertisements, direct access table iteration module 112 may award the slot to the advertisement before proceeding on to the next impression slot in the table. In order to re-link advertisements to another impression slot, direct access table iteration module 112 may prompt impression table iteration module 110 for further action. For impression slots without linked advertisements, direct access table iteration module 112 may skip the impression slot and leave it empty.

In an embodiment, link module 114, increment module 116, and comparator module 118 perform component steps involved in several other modules, such as ad iteration module 108, impression table iteration module 110, and direct access table iteration module 112. Link module 114 establishes a temporary association (link) between advertisements and impression slots. This link may be formed by adding a pointer to impression slots that point to a specific advertisement or vice versa. Link module 114 may also be used to remove the links and establish new links between different pairs of advertisements and impression slots. Increment module 116 allows other modules to cycle through various lists, such as the impression slots in a direct access table or impression sets in an impression table. For example, when direct access table iteration module 112 determines that an impression slot has already been awarded, it may indicate to increment module 116 to move to the next impression slot. Similarly, increment module 116 is prompted to shift between different impression sets in an impression table when while impression table iteration module 110 is attempting to link or award advertisements to impression slots. Comparator module 118 is used by impression table iteration module 110 primarily to resolve contentions. When link module 114 attempts to link an advertisement into an impression slot that is already linked to another advertisement, comparator module 118 compares the values of each advertisement to determine the next course of action (e.g., keep the existing link or re-link the impression slot to the new advertisement.

Ad database 120, in an embodiment, contains a store of advertisements available for advertisement inventory server 100 to select from. Advertisements from ad database 120 are submitted by advertisement providers or other entities to a media content provider to be included in media content distributed by the content provider, in return for payment. Other modules retrieve advertisements from ad database 120 as needed. In some embodiments, advertisements stored in ad database 120 may be stored along with their extracted impression sets. In other embodiments, advertisements may be stored with reference links that point to an associated impression set, which may be stored in an impressions database 122.

Impressions database 122, in an embodiment, stores the possible list of impressions that may be associated with advertisements. Impression types may be identified by operators and saved within impressions database 122 as a template for advertisement inventory server 100 to identify advertisements with. In other embodiments, impressions database 122 may also generate new impressions as necessary according to newly acquired advertisements. In some embodiments, impression sets extracted from advertisements may also be stored in impressions database with reference links connecting the advertisement in ad database 120 with the impression set in impressions database 122.

Direct access table 124 is an index that lists the impression slots available for advertisements to link to and be awarded with, in accordance with an embodiment. Impressions in a direct access table 124 may be represented in an embodiment using integers. This arrangement allows impressions to be ordered “sequentially” on a direct access table 124 by number value and also allows impression sets to contain impressions sorted by representative numbers. Direct access table 124, in an embodiment, may also contain a list of pointers (one associated with each impression slot). These pointers are initially zeroed out but are assigned as impression slots are linked and awarded to advertisements. Advertisement inventory server 100 may reference direct access table 124 to determine which advertisements are linked/awarded to which impression slots in real-time. If a query was submitted to the advertisement inventory server 100, the query results may also be determined from impression slots that were awarded to the query. As different modules cycle through the advertisement impression sets and direct access table 124, each impression slot on direct access table 124 is first linked to an advertisement that has a corresponding impression. After verifying that the linked advertisement has highest value compared to other advertisements competing for the same slot, impression slots on the direct access table 124 are awarded to the linked advertisement.

### Example Inventory Identification and Query Processing Method

Having described an example advertisement system 100, the disclosure now turns to FIG. 2, which illustrates the exemplary method embodiment for inventory identification and query processing. The example method is discussed in terms of an exemplary advertisement system 100 as described and shown in FIG. 1, which is configured to practice the method. The steps outlined herein are exemplary and can be implemented in any combination thereof, including combinations that exclude, add, or modify certain steps.

To begin identifying unsold inventory and processing queries, the advertisement inventory server 100 retrieves 202 the advertisements, impression templates, and queries from ad database 120, impressions database 122, and operator inputs. This request can be such that an entire advertisement store is requested at once or one at a time as ad analyzer module 104 analyzes the advertisements. Furthermore, advertisement system 100 may also impose a pre-filter during advertisement retrieval so that only desired advertisements are retrieved. For example, the filter may exclude advertisements that were submitted before a certain date, advertisements belonging to advertisement providers no longer providing payment to a media content provider, restricted advertisements and the like. In an embodiment, advertisement inventory server 100 may retrieve 202 queries from requests sent from advertisement providers or other entities through user interface module 102. Operators may input the specifications of the query for advertisement inventory server 100 to process the query along with the advertisements during inventory determination.

Ad analyzer module 104 then analyzes and identifies 204 impression sets for each advertisement. Ad analyzer module 104 may extract impressions from each advertisement through various methods. For example, advertisement providers may attach metadata to submitted advertisements detailing the impressions of the advertisements. In this scenario, ad analyzer module 104 extracts the metadata and converts it into an impression set. Impression sets are a group of impressions that identify an advertisement, or alternatively, a group of impressions that an advertisement can be categorized as. Ad analyzer module 104 may also run various video and audio analysis algorithms to detect key words/images and patterns within the advertisement and extract key information from these detections. Using the key information, ad analyzer module 104 may then infer impressions that an advertisement might have. Ad analyzer module 104 organizes these impressions into impression sets. Thus, each advertisement retrieved 202 from ad database 120 has an impression set associated with it.

Impression table generator module 106 processes the different advertisements and impression sets and generates an impression table. An impression table lists the retrieved 202 advertisements and their corresponding values and impression sets. An impression table can be quickly and easily cycled through to determine all impressions associated with an advertisement and all available advertisements that are candidates for impression slots.

Advertisement inventory server 100 then begins completing direct access table 124 by linking 208 advertisements to an impression slot. Each advertisement may only be linked 208 (e.g., using a pointer) to one impression slot on the direct access table based on the initial impression in an advertisement's impression set. Since impression slots are labeled by index value on the direct access table 124, the impressions that each impression slot represents may also be labeled with the same index value. Therefore, impressions in impression sets and impression tables may be substituted with the corresponding index value. By replacing impressions in an impression table with numbers, the impression table can be ordered numerically so that impression table iteration module 110 cycles through impressions in order of number.

Each advertisement is linked 208 to the impression slot corresponding to the first possible impression in the advertisement's impression table, which is organized by number. If another advertisement is in contention for the same impression slot, the higher valued advertisement is linked 208 to the impression slot. For the advertisement that did not gain or keep that impression slot, impression table iteration module 110 increments to the next impression in the advertisement's impression table and attempts to link 208 to the corresponding impression slot. The linking cycle continues on for each advertisement until all advertisements have either been linked 208 to the direct access table 124 or removed from consideration (e.g., due to higher valued advertisements contending for the same impression slots).

If present, queries are treated uniquely from other advertisements. When queries are linked 208 to the direct access table 124 at this stage in the process, they automatically remove existing links and block other advertisements from linking to the requested impression slots. The queries represent impression slots that advertisement providers are interested in or media content providers are interested in maximizing value from. These queries act as impression slot blocks during the first iteration of awarding impression slots 210 and are not removed until the second iteration of awarding impression slots 212.

Advertisement inventory server 100 then runs 210 the first iteration of awarding impression slots and re-linking advertisements to subsequent impression slots. Starting at the first impression slot in the direct access table 124, advertisement inventory server 100 starts to award impression slots to linked advertisements. Since each advertisement may only be linked at most to one impression slot at a time, the advertisement is re-linked to a subsequent impression slot represented by the next impression in its impression set after being awarded a slot. If that impression slot is already linked to another advertisement, advertisement inventory server 100 compares the values of the contending advertisements and links the higher valued advertisement to the impression slot. Unlinked advertisements are then linked to the next impression slot according to the next impression in its impression set. If no further impressions exist in its impression set, then the advertisement is not linked to any later impressions and is removed from further consideration. If not advertisements are linked to certain impression slots, then advertisement inventory server 100 skips those slots and moves on to the following impression slot. Furthermore, impression slots blocked by queries are not available to be linked to by other advertisements. This cycle continues until advertisement inventory server 100 has finished iterating through the entire direct access table 124.

Following the first iteration run 210, advertisement inventory server 100 runs 212 a second iteration of awarding impression slots and re-linking advertisements to subsequent impression slots. While both runs start using a direct access table 124 in the same state (with the advertisements linked to the same initial impression slots), the second run 212 does not have the same query blocks as the first run 210. During the second run 212, a query has its own value and is treated as an advertisement. Thus, a query is linked to only one impression slot at a time and contends with other advertisements for impression slots. It also should be pointed out that the first phase is just like the second one except that all of the non-query slots are blocked. After the second run 212 completes, the results of the direct access table 214 are returned to the advertisement inventory server 100. In some embodiments, the second run 212 is not performed. In other embodiments, subsequent runs after the second run 212 may be performed. The first pass is outside of the query scope to try and fulfill the advertisement's quota without using the query space at all. This same approach could be used with less important advertisements on the first pass, then more important on the second, even more important on the third, and so on. A single pass may be done without any query, but with just the advertisement's weights and quotas changed. This can be used to optimize result delivery. The results may be processed in order to determine which inventory slots are unsold and are available for advertisers to fill with their own advertisers. In an embodiment, advertisers may use the information provided about the unsold inventory slots to bid for the slots against other advertisers. In another embodiment, advertisers may use the information provided about the unsold inventory slots to determine what value they should put in the advertisement in order to gain a preferred slot. Advertisement inventory server operators may also use the information to determine the unsold inventory of impression slots as well as the results of the queries.

### Example Impression Set Linking Method

Having described an example for identifying inventory and processing queries, the disclosure now turns to FIG. 3, which illustrates an exemplary method embodiment for initially linking 208 advertisements to a direct access table 124. Initially linking 208 advertisements to corresponding impression slots on a direct access table 124 can be broken down into ad iteration 310 and impression table iteration 330.

Ad iteration 310 is an embodiment of a method for cycling through a selection of advertisements in an impression table, allowing each advertisement to be given an opportunity to link to an impression slot. Once all advertisements are linked to impression slots, ad iteration 310 completes.

Ad iteration 310 may be performed by ad iteration module 108. Ad iteration module 108 starts at the first advertisement 302 in the impression table and identifies 310 whether the advertisement is already linked to the direct access table 124. If the advertisement is linked, then ad iteration module 108 determines whether subsequent advertisements exist 312 in the impression table. If advertisements exist, then ad iteration module 108 increments 314 to the next advertisement in the impression table and repeats the process. If no subsequent advertisements exist, then advertisement inventory server 100 proceeds on to awarding and re-linking advertisements. However, if ad iteration module 108 identifies advertisements that are not linked to the direct access table 124 at 310, then it will select the first impression in the advertisement's impression set and initiate the impression table iteration 330.

Impression table iteration 330 is an embodiment of a method for cycling through an impression table and attempting to link an advertisement to impression slots, according to impressions listed in its impression set. If no open impression slots can be found, then the advertisement is removed from further consideration. When impression slot contentions occur, impression table iteration module 110 link the impression slot to the highest valued advertisement and attempts to re-link the other advertisement according to its impression table. Impression table iteration 330 may be performed by impression table iteration module 110.

When ad iteration module 108 selects 316 the initial impression in an advertisement's impression set and initiates the impression table iteration 330, impression table iteration module 110 identifies whether the corresponding impression slot is blocked. If the slot is blocked, then impression table iteration module 110 identifies whether subsequent impressions exist in the advertisement's impression set 334. If subsequent impressions exist, then impression table iteration module 110 increments 336 to the next impression and starts the process again. If no subsequent impressions exist, then the advertisement is not linked to any impression slots and is removed 338 from further consideration. In an embodiment, the impression slot may be blocked because a query has one of the impression slots referenced in its set of impression IDs. For example, during a first iteration, the advertisement inventory server may block queried impression slots. In other embodiments, an impression slot may be blocked because it was not referenced by a query. For example, during a second iteration, the advertisement inventory server may block non-queried impression slots. In some embodiments, impression slots may be blocked by the advertisement inventory server for other reasons, such as based on outside determinates, such as a pre-determined algorithm, operator settings, more elaborate advertisement comparisons, change in advertisements being compared, change in advertisement weightings/values and so forth.

If an impression slot is not blocked by a query at 332, then impression table iteration module 110 determines whether the slot is being contended for by other advertisements. If not, then the advertisement is linked 342 to that impression slot and ad iteration 310 is initiated again and advertisement inventory server 100 continues to link subsequent advertisements to the direct access table 124.

If the impression slot is being contended for by other advertisements at 340, then impression table iteration module 110 compares the two advertisements to determine which has the higher value. The higher valued advertisement is linked to the impression slot and the other advertisement cycles to the next impression in its impression set in an attempt to link to later impression slots. For example, if the selected advertisement has a higher value, then it is linked 346 to the impression slow, overwriting the existing/contending advertisement's link. The impression table iteration module 110 then selects the contending advertisement 348, attempts to identify if subsequent impressions exist in its impression set 334, and continues impression table iteration 330 with the contending advertisement. Conversely, if the existing advertisement has a higher value at 344, then the impression table iteration module 110 identifies whether the selected advertisement has subsequent impressions in its impression set 334 and continues impression table iteration 330 with the selected advertisement.

Once all advertisements have either been linked 342, 346 to the direct access table 124 or removed from consideration 338, advertisement inventory server 100 continues 350 on to the next stage and performs the awarding of impression slots to advertisements 210, 212.

### Example Impression Slot Awarding Method

Having described an exemplary method embodiment for initially linking 208 advertisements to a direct access table 124, the disclosure now turns to FIG. 4, which illustrates an exemplary method embodiment for awarding impression slots to advertisements. Impression slot awarding can be broken down into direct access table iteration 410 and impressions table iteration 430. Impression slot awarding involves a direct access table iteration module 112, impression table iteration module 110, link module 114, increment module 116, comparator module, and direct access table 124. In some embodiments, there may be one iteration for awarding impression slots to advertisements. In other embodiments, there may be a plurality of iterations for awarding impression slots to advertisements. For example, the first iteration may have the queried impression slots blocked from linking and awarding while the second iteration may have all other impression slots (other than the queried impression slots) blocked from linking and awarding.

Once advertisements are linked 208 into the direct access table, direct access table iteration module 112 begins to cycle through the various impression slots on the direct access table 124. By cycling through and awarding impression slots to linked advertisements, advertisement inventory server 100 ensures that each impression slot is awarded to an advertisement, with non-awarded impression slots indicating available (unsold) inventory or query blocks.

Starting from the first impression slot, direct access table iteration module 112 checks whether an advertisement is linked to the impression slot 412. If not, then direct access table iteration module 112 checks whether subsequent impression slots exist 414 in the direct access table 124. If not, then the process of awarding impression slots to advertisements is finished and the direct access table 124 is returned 450. However, if subsequent impression slots exist, then direct access table iteration module 112 increments 416 to the next slot and repeats.

However, if an advertisement is linked to the impression slot at 412, then the impression slot is awarded 418 to the linked advertisement. After awarding 418 the impression slot, the advertisement may be re-linked to a subsequent impression in its impression set. To re-link the advertisement, direct access table iteration module 112 prompts impression table iteration module 110 to cycle through the advertisement's impression set as part of the impression table iteration 430 process.

Impression table iteration 430 represents an embodiment of cycling through an impression table, linking advertisements to impression slots. As advertisements are awarded impression slots, advertisement server 100 re-links them to later impression slots through the impression table iteration 430. Linking advertisements to impression slots provides the basis for direct access table iteration 410 to award the slots to advertisements.

Impression table iteration 430 starts after an advertisement is awarded 418 an impression slot. Impression table iteration module 110 checks whether the advertisement has any subsequent impressions in its impression set 432. If not, then the advertisement is removed 434 from further consideration and advertisement server 100 begins cycling through the direct access table iteration 410 process again. However, if subsequent impressions do exist in the impression set, then impression table iteration module 110 attempts 436 to link the advertisement to the next impression in its impression set. If the targeted impression slot is blocked by a query 438, then impression table iteration module 110 skips that impression slot and increments to the next impression in the advertisement's impression set, if subsequent impressions exist.

If the targeted impression slot in not blocked by a query at 438, then impression table iteration module 110 checks whether the impression slot is contended for or linked to by another advertisement 440. If not, then the advertisement is linked 442 to the impression slot and advertisement server 100 continues to cycle through the direct access table 124. However, if the impression slot is contended for by another advertisement, then advertisement server 100 selects the larger valued advertisement to link to the impression slot.

If the existing/contending advertisement has the larger value at 444, then the selected advertisement skips that impression slot and attempts to link to a subsequent impression slot in its impression set. However, if the selected advertisement has the larger value at 444, then it is linked 446 to the impression slot and the contending advertisement's linked is removed. Thereafter, impression table iteration module 110 cycles through the contending/overwritten advertisement's impression set to attempt to link the overwritten advertisement to another impression slot.

### Example Impression Slot Allocation

Having disclosed an exemplary method embodiment for initially linking 208 advertisements to a direct access table 124, the disclosure now turns to FIG. 5A, which illustrates an exemplary embodiment for a first iteration of awarding impression slots to advertisements 210. In the example illustrated by FIG. 5A, advertisement inventory server 100 has three advertisements: AD1, AD2, and AD3. Each advertisement has its own value (AD1 is 10 points, AD2 is 15 points, AD3 is 30 points). Furthermore, a query is included that is worth 20 points. Each advertisement and query is arranged with its impression set into impression table 505. In an embodiment, the impression sets contain numbers representing the impressions of the advertisement, organized by increasing numbers. Each impression number corresponds to an impression slot on a direct access table 124. For example, AD1 has impression IDs of 1, 3, 7 and 10. Therefore, AD1 has attributes or impressions that enable it to fill impression slots 1, 3, 7, and 10. The query also has an impression set of impressions that it is inquiring about, as well as a value to compare with other advertisements. During the first iteration 212, the query acts as a block for impression slots represented in its impression set (e.g., impression slots 3, 4, 5, and 6 in the scenario illustrated in FIG. 5A).

After each advertisement has been linked 208 into the direct access table 124, the direct access table 124 is in a state represented by view 1 (510). AD1 is linked to impression slot 1, AD2 is linked to impression slot 2, and the query has blocked impression slots 3, 4, 5, and 6. The first impression in AD3's impression set is impression 4, but impression slot 4 is blocked by the query. Thus, AD3 is linked to the following impression slot indicated by the next impression in its impression set, which is impression slot 8.

During the awarding and re-linking cycles 210, AD1 and AD2 are awarded the impression slots that they had been linked to. They are re-linked to the impression slots represented by the next impression in each of their impression set, which are impression slot 7 for AD1 and impression slot 10 for AD2. Impression slot 3 is blocked by the query, so both AD1 and AD2 were unable to link to it. At this stage, direct access table 124 is represented by view 2 (512).

Advertisement inventory server 100 is unable to award impression slots 3, 4, 5, or 6 to any advertisements due to the query's block and so continues on to award impression slot 7 to AD1. Upon an attempt to re-link, AD1 contends with AD2 for impression slot 10. However, AD2 has a higher value than AD 1 and retains the link to impression slot 10. Since AD 1 does not have any more impressions in its impression set, it is removed from consideration. Advertisement inventory server 100 then awards impression slot 8 to AD3 and re-links AD3 to impression slot 9. View 3 (514) is an illustration of the direct access table 124 at this stage.

Once AD3 is awarded impression slot 9, it attempts to re-link to impression slot 10. Because it has a higher value than AD2, it is successful in re-linking to impression slot 10, forcing AD2 to re-link to impression slot 12. View 4 (516) is an illustration of the direct access table 124 at this stage.

Advertisement inventory server 100 continues cycling down the list of impression slots in direct access table 124, awarding impression slot 10 to AD3. Because AD3 does not have any further impressions in its impression set, it is removed from further consideration. Since no advertisements are linked to impression slot 11, advertisement inventory server 100 skips this impression slot and award impression slot 12 to AD2. At this point, all impression slots in direct access table 124 have been award and the advertisement inventory server 100 returns the results, which are represented by view 5 (518). To summarize, after the first iteration 210, impression slots 1, 2, 7, 8, 9, 10, and 12 have been awarded to advertisements, impression slot 11 represents unsold inventory, and impression slots 3, 4, 5, and 6 are impression slots that the query was investigating.

Having disclosed an exemplary embodiment for a first iteration of linking and awarding impression slots to advertisements 210, the disclosure now turns to FIG. 5B, which illustrates an exemplary embodiment for a second iteration of linking and awarding impression slots to advertisements 212. After the first iteration of awarding impression slots 210 is completed, advertisement inventory server 100 begins running the second iteration of awarding impression slots 212. In this exemplary embodiment, the advertisement inventory server 100 blocks out impression slots that are not referenced by the query. Thus in this example, slots 1, 2 and 7-12 are blocked out during the second iteration. Thus, view 1 (520) shows the new direct access table 124 with each advertisement and query linked to their initial impression slots. For initial linking, AD1 may be linked to impression slot 3; however, it is replaced by the query in view 2 (522) because the query has a larger value. Because AD1 does not have any further impression ID that corresponds to open impression slots, it is removed from consideration. AD3, which has a higher value than the query, remains linked to impression slot 4. During the awarding steps, impression slot 3 is awarded to the query in view 3 (524) while AD3 is awarded impression slot 4. Because AD3 does not have any further impression IDs that are not blocked, it is also removed from consideration. However, the query is linked to impression slot 5 in view 3 (524). Because the query does not have any more competing advertisements for the remaining impression slots, it is linked to and awarded impression slots 5 and 6 in the subsequent views 4 (526) and 5 (528). In this exemplary embodiment, three advertisements, one query, and a 12-slot direct access table were used. However, other embodiments may contain different numbers of advertisements, queries, and/or direct access table slots.

### Additional Considerations

Embodiments may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope. For example, the principles herein apply equally to video media as to audio media. Those skilled in the art will readily recognize various modifications and changes that may be made to the principles described herein without following the example embodiments and applications illustrated and described herein, and without departing from the spirit and scope.

What is claimed is:

1. A method comprising:
receiving query requests for advertisement placement;
retrieving, from databases, advertisements and impression templates;
identifying, based at least in part on impression templates and provided metadata associated with the advertisements, impression sets for each advertisement;
generating, based at least in part on the advertisements and their associated impression set, an impression table;
linking, based at least in part on associations in an impression table and value, advertisements to corresponding impression slots in a direct access table;
awarding, based at least in part on associations in an impression table and value, impression slots to advertisements and re-linking advertisements, the awarding comprising assigning impression slots to an advertisement; and
returning the results of the direct access table.

2. The method of claim 1, wherein linking and awarding impression slots to advertisements may be performed one or more times, each with varying impression slots restricted from linking or awarding.

3. The method of claim 2, wherein impression slots associated with queries are blocked during a first iteration of linking and awarding.

4. The method of claim 2, wherein impression slots other than those associated with queries are blocked during a second iteration of linking and awarding.

5. The method of claim 1, wherein an advertisement consists of: short video clips, long infomercials, pop-up windows, screen overlays, embedded metadata, images, or any combination thereof.

6. The method of claim 1, wherein the query represents an advertisement provider or other entities' intended advertisement of specified impressions and value.

7. The method of claim 1, wherein an impression consists of: targeted demographics, content, type, length, provider or any combination thereof for each advertisement.

8. The method of claim 1, wherein a direct access table consists of impression slots, each associated to a pointer.

9. The method of claim 8, wherein each impression slot corresponds to an advertisement impression.

10. The method of claim 8, wherein pointers are either a link or an award to advertisements.

11. The method of claim 1, wherein queries block specific impression slots from being linked to during the first iteration.

12. The method of claim 11, wherein queries contend for impression slots with other advertisements during the second iteration.

13. The method of claim 1, wherein value is determined at least in part by revenue, benefits, or goodwill generated for the media content provider.

14. A method comprising:
identifying, based at least in part on impression templates and provided metadata associated with one or more advertisements, categories for each advertisement;
generating, based at least in part on the advertisements and their associated impression set, a categorization table;
assigning, based at least in part on associations between an advertisement and slots on the categorization table, impression slots to advertisements;
returning the results of the direct access table.

15. The method of claim 14, wherein the assigning of impression slots to advertisements further comprises:
linking, based at least in part on associations in the categorization table and a value, advertisements to corresponding impression slots in a direct access table;

16. The method of claim 14, wherein the assigning of impression slots to advertisements occurs in two iterations.

17. The method of claim 16, wherein query requests may be retrieved that block specific impression slots during the first iteration and are available for assigning during the second iteration.

18. A non-transitory computer-readable storage medium storing instructions executable by one or more processors, the instructions when executed causing the one or more processors to perform steps comprising:
receiving query requests for advertisement placement;
retrieving, from databases, advertisements and impression templates;
identifying, based at least in part on impression templates and provided metadata associated with the advertisements, impression sets for each advertisement;
generating, based at least in part on the advertisements and their associated impression set, an impression table;
linking, based at least in part on associations in an impression table and value, advertisements to corresponding impression slots in a direct access table;
awarding, based at least in part on associations in an impression table and value, impression slots to advertisements and re-linking advertisements, the awarding comprising assigning impression slots to an advertisement; and
returning the results of the direct access table.

19. The non-transitory computer-readable storage medium of claim 18, wherein linking and awarding impression slots to advertisements may be performed one or more times, each with varying impression slots restricted from linking or awarding.

20. The non-transitory computer-readable storage medium of claim 18, wherein impression slots associated with queries are blocked during a first iteration of linking and awarding.
